(19) United States
(12) Patent Application Publication
(10) Pub. No.: US 2008/0158585 A1
(43) Pub. Date: Jul. 3, 2008

(54) Apparatus, method, program for supporting printing, system, method, and program for printing, and recording medium

(75) Inventor: Shinji Miwa, Suwa (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/005,604

(22) Filed: Dec. 27, 2007

(30) Foreign Application Priority Data
Dec. 27, 2006 (JP) 2006-351209
Jan. 26, 2007 (JP) 2007-015932

(51) Int. Cl. G06F 15/00

(52) U.S. Cl. 358/1.13; 358/1.15

(57) ABSTRACT

A print support apparatus includes: a print-job-definition-data input section that receives input of print-job definition data describing print specifications; a printer-capability-information acquisition section that obtains capability information on an available printer; a post-printing-processor-capability-information acquisition section that obtains capability information on an available post-printing processor; a print-specification determination section that determines print specifications to be implemented, according to the print specifications described in the print-job definition data, the printer capability information, and the post-printing-processor capability information; a first generation section that generates print-job setting data describing print settings for executing printing according to the print specifications; a second generation section that generates post-printing-process-job setting data describing post-printing-process settings for executing postprocessing of a print medium printed according to the print specifications; a first output section that outputs the print-job setting data generated by the first generation section; and a second output section that outputs the post-printing-process-job setting data generated by the second generation section.

The entire disclosure of Japanese Patent Application Nos: 2006-351209, filed Dec. 27, 2006 and 2007-015932, filed Jan. 26, 2007 are expressly incorporated by reference herein.

### BACKGROUND

1. Technical Field

The present invention relates to an apparatus, a method, and a program for supporting printing and post-printing processing according to print-job definition data, a system, a program, and a program for printing according to the same, and a recording medium.

2. Related Art

It is known in the art to provide a method for controlling printing of print data written in a page description language (PDL) such as PostScript (registered by Adobe Systems, United States) using print-job definition data under Document Printing Application (DPA), Job Definition Format (JDF) or the like.

Various systems for executing printing and post-printing processing according to such print-job definition data have been proposed. One example is disclosed in JP-A-11-52802, which provides an image-forming apparatus capable of automatic setting of paper folding according to print mode, document size, and paper size. This apparatus is configured such that: if there is no paper of the same size as the document, with a two-sided copy mode selected, the mode is switched to a one-sided copy mode, and paper twice the size of the present paper is selected, on which two pages of the document are copied; and when it is ejected, the paper is folded at the center so that the copied face can be viewed, and then they are stapled.

JP-2002-29119 discloses an apparatus configured such that even if the processing function of the machine does not meet set postprocessing conditions, the apparatus responds to another processing condition required by the user, if present, without cancelling the setting of the postprocessing at once. If the machine does not match the staple position set in the print job, the apparatus inquires of the user whether to execute the print job under an alternative processing condition (a change in the staple position) that can be supported by the machine and executes printing under the alternative condition according to the instruction of the user. When a reply from the user is not to execute printing under the alternative condition or when no replay is given in a predetermined time, printing is executed while cancelling the staple mode.

However, both the above-described apparatuses have the problem that if the apparatuses receive a job request that cannot be responded by the postprocessor built in the printer, an alternative setting is limited to “staple position/side stitch binding→one-sided printing+thread stitch binding”, so that print job setting suitable for general print job specifications, printer capability, and post-printing postprocessor capability cannot be obtained.

Furthermore, the foregoing apparatuses do not consider automatic changes of the settings of printers/post-printing processors to requested print job specifications even if alternative print job settings are required because of limitations of the capability of the printer/post-printing processors.

### SUMMARY

An advantage of some aspects of the invention is to provide an apparatus, a method, and a program for supporting printing and post-printing processing according to obtained capability information on an available post-printing processor and print-job definition data, and if necessary, using changed print specifications, and to provide a system, a method, and a program for printing according to the same, and recording media.

### BRIEF DESCRIPTION OF THE DRAWINGS

The invention will be described with reference to the accompanying drawings, wherein like numbers reference like elements.

FIG. 1 is a block diagram of a print support apparatus according to an embodiment of the invention.

FIG. 2 is a conceptual diagram of the print support apparatus of the embodiment in a state in which it is connected to multiple printers and post-printing processors via a network.

FIG. 3 is a functional block diagram showing the hardware structure of a computer system.

FIG. 4 is a flowchart for the process of the print support apparatus according to the embodiment of the invention.

FIG. 5 is a diagram showing an example of content data.

FIG. 6 is a diagram showing an example of content-processing-information-setting data.

FIG. 7 is a diagram showing an example of print-job setting data.

FIG. 8 is a diagram showing an example of post-printing processing setting data.

FIG. 9 is a schematic diagram of a folding machine.

FIG. 10 is a diagram showing an example of printer capability information.

FIG. 11 is a diagram showing another example of printer capability information.

FIG. 12 is a diagram showing an example of post-printing-processor capability information.

FIG. 13 is a diagram showing another example of post-printing-processor capability information.

FIG. 14 is a block diagram showing the internal structure of a print-specification determination section.

FIG. 15 is a flowchart for the process of the print-specification determination section.

FIG. 16A is a diagram showing an example print-job setting rules.

FIG. 16B is a diagram showing an example print-job setting rules.

FIG. 17A is a diagram showing another example print-job setting rules.

FIG. 17B is a diagram showing another example print-job setting rules.

FIG. 18 is a diagram showing an example of content-processing setting data.

FIG. 19 is a diagram showing an example of print-job setting data.

FIG. 20 is a diagram showing an example of post-printing-processing-job setting data.

FIG. 21 is a diagram showing another example of post-printing-processing-job setting data.

### DESCRIPTION OF EXEMPLARY EMBODIMENTS

A print support apparatus according to an embodiment of the invention will be described hereinbelow. The print support apparatus can be applied as a printer with a print section or a combination of components having the functions of the print support apparatus.

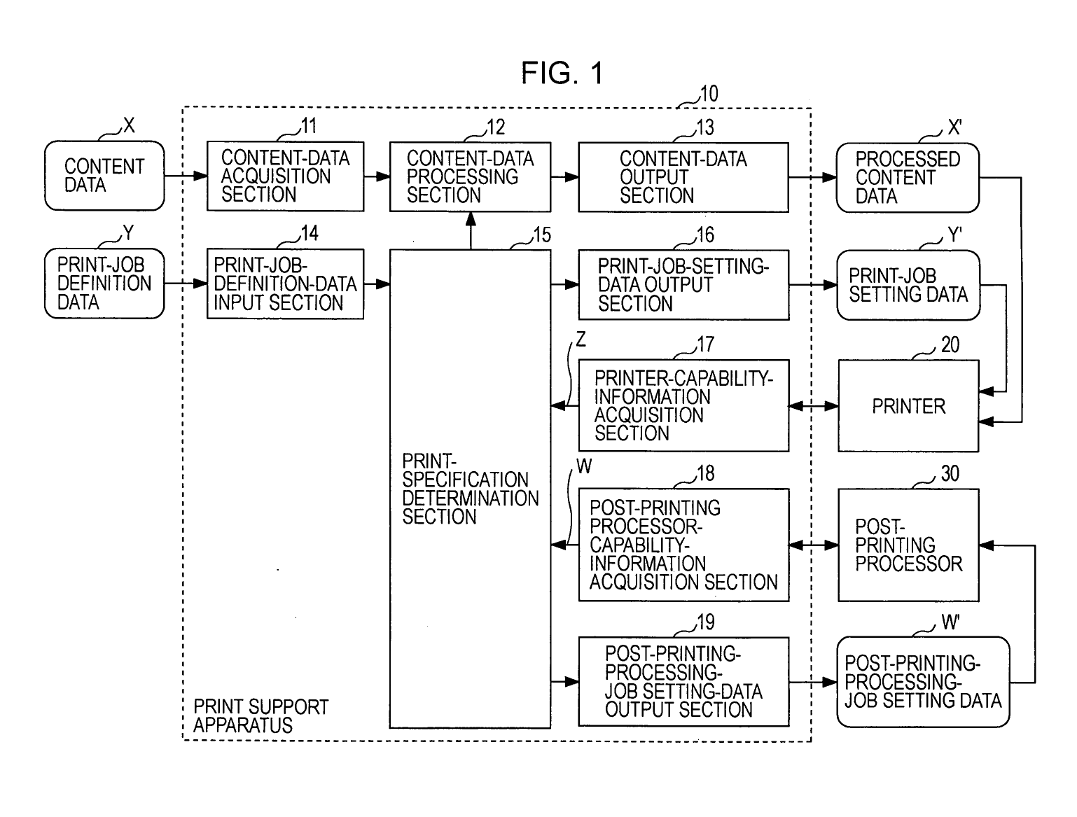

FIG. 1 is a block diagram of a print support apparatus according to an embodiment of the invention.

The print support apparatus 10 includes a content-data acquisition section 11, a content-data processing section 12, a content-data output section 13, a print-job-definition-data input section 14, a print-specification determination section 15, a print-job-setting-data output section 16, a printer-capability-information acquisition section 17, a post-printing-processor-capability-information acquisition section 18, and a post-printing-processing-job-setting-data output section 19. Examples of data are content data X, print-job definition data Y, processed content data X′, print-job setting data Y′, printer capability information Z, post-printing-processor capability information W, and post-printing-processing-job setting data W′.

The content-data acquisition section 11 receives input of content data X contained in print data sent from the user.

The print-job-definition-data input section 14 receives input of the print-job definition data Y contained in print data sent from the user.

The print-specification determination section 15 takes in the print-job definition data Y obtained by the print-job-definition-data input section 14, and converts it to print-job setting data Y′ to make it printable by the printer 20. The print-specification determination section 15 generates post-printing-processing-job setting data W on the basis of the converted print-job setting data Y′ and the post-printing-processor capability information W obtained by the post-printing processor-capability-information acquisition section 18.

The print-job-setting-data output section 16 outputs the print-job setting data Y′ converted by the print-specification determination section 15 to the printer 20.

The content-data processing section 12 processes the content data X obtained by the content-data acquisition section 11 to generate the processed content data X′ to print it.

The content-data output section 13 outputs the content data X′ processed by the content-data processing section 12 to the printer 20.

The printer-capability-information acquisition section 17 obtains printer-capability information on the printer 20 from the printer 20. The printer-capability-information acquisition section 17 may be connected to the printer 20 either directly or via radio communication such as the Internet.

The post-printing processor-capability-information acquisition section 18 obtains post-printing processor-capability information on the post-printing processor 30 from the post-printing processor 30. The post-printing processor-capability-information acquisition section 18 may be connected to the post-printing processor 30 either directly or via radio communication such as the Internet.

The post-printing-processing-job-setting-data output section 19 outputs the post-printing-processing-job setting data W′ generated by the print-specification determination section 15 to the post-printing processor 30.

With this arrangement, after the printer-capability-information acquisition section 17 obtains capability information on an available printer, and the post-printing-processor-capability-information acquisition section 18 obtains capability information on an available post-printing processor, the print-specification determination section 15 determines print specifications to be implemented according to the print specifications described in the print-job definition data Y received by the print-job-definition-data input section 14, the printer capability information obtained by the printer-capability-information acquisition section 17, and the post-printing-processor capability information obtained by the post-printing-processor-capability-information acquisition section 18. The print support apparatus 10 thus generates print-job setting data describing print settings for executing printing according to the print specifications and post-printing-process-job setting data describing post-printing-process settings for executing postprocessing of a print medium printed according to the print specifications are generated. Thus, printing and post-printing processing can be executed according to the obtained printer capability information, the obtained post-printing-processor-capability information, and the print-job definition data, or print specifications may be changed as necessary, so that print-job definition data can be generated according to the changed print specifications. This allows an automatic search for process flow for implementing print specifications according to the combination of an available printer and postprocessor, and generation of print-job setting data corresponding to the respective machines.

Moreover, the content-data acquisition section 11 obtains content data associated with the print-job definition data received by the print-job-definition-data input section 14; the content-data processing section 12 processes the content data obtained in the content-data acquisition step on the basis of the print specifications determined by the print-specification determination section 15; and a print instruction section instructs the printer to print the content data processed by the content-data processing section 12 according to the description of the print-job setting data output from the post-printing-processing-job-setting-data output section 19. Thus, printing and post-printing processing can be executed according to the obtained printer capability information, the obtained post-printing-processor-capability information, and the print-job definition data, or print specifications may be changed as necessary, so that print-job definition data can be generated according to the changed print specifications. This allows an automatic search for process flow for implementing print specifications according to the combination of an available printer and postprocessor and generation of print-job setting data corresponding to the respective machines. Moreover, the content data is appropriately processed by the content-data processing section 12, so that there is no need to process the content data manually.

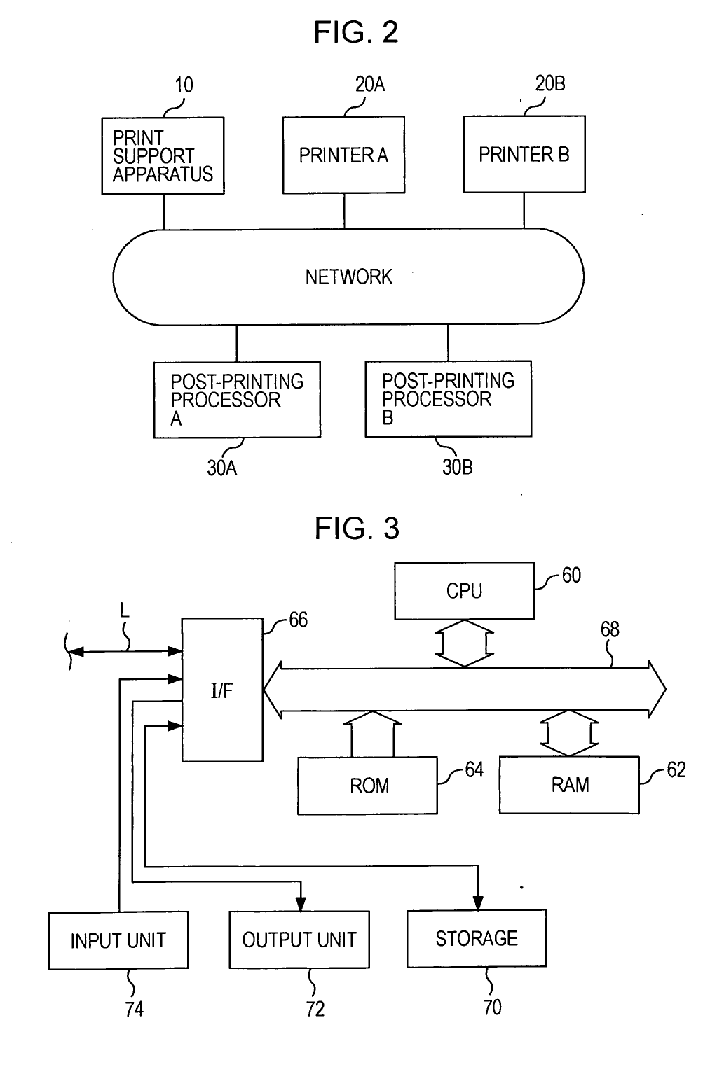

FIG. 2 is a conceptual diagram of the print support apparatus of this embodiment in a state in which it is connected to multiple printers and post-printing processors via network.

As shown in the drawing, the print support apparatus 10, printers 20A and 20B, and post-printing processors 30A and 30B are connected via the same network. In this example, the print support apparatus 10 is connected to two printers 20 and two post-printing processors 30.

As described above, the printer-capability-information acquisition section 17 may be connected to the printer 20 by radio communication such as the Internet, and the post-printing processor-capability-information acquisition section 18 may be connected to the post-printing processor 30 by radio communication such as the Internet. That is, as shown in the drawing, the print support apparatus 10, the printers 20A and 20B, and the post-printing processors 30A and 30B can exchange data via the same network.

Therefore, even if the printer 20 or the post-printing processor 30 is not disposed in the vicinity of the print support apparatus 10, the print support apparatus 10 can obtain printer-capability information from the printer 20 or post-printing-processor capability information from the post-printing processor 30. Therefore, only necessary information can be extracted for use by obtaining information on an available printer 20 or post-printing processor 30 in advance, allowing its print specifications to be determined in a short time.

FIG. 3 is a functional block diagram showing the hardware structure of a computer system.

The print support apparatus 10 has a computer system for implementing the content-data acquisition section 11, the content-data processing section 12, the content-data output section 13, the print-job-definition-data input section 14, the print-specification determination section 15, the print-job-setting-data output section 16, the printer-capability-information acquisition section 17, the post-printing processor-capability-information acquisition section 18, and the post-printing-processing-job-setting-data output section 19 on software. The computer system has a hardware structure shown in FIG. 3, in which a central processing unit (CPU) 60 taking charge of various controls and operations, a random access memory (RAM) 60 serving as a main storage, and a read-only memory (ROM) 64 are connected via various internal and external buses 68 including the Peripheral Component Interconnect (PCI) bus and the Industrial Standard Architecture (ISA) bus, and in which an external storage (secondary storage) 70 such as a hard disk drive (HDD), an output unit 72 such as printing means and a CRT or CLD monitor, an input unit 74 such as an operation panel, a mouse, a keyboard, and a scanner, and a network L for communication with a print instructing unit (not shown) are connected to the bus 68 via an input/output interface (I/F) 66.

On power-up, a system program, such as BIOS, stored in the ROM 64 or the like loads various dedicated computer programs stored in the ROM 64 or various dedicated computer programs installed in the storage 70 via a storage medium such as a CD-ROM, DVD-ROM, or flexible disk (FD) or the communication network L such as the Internet on the RAM 62, and the CPU 60 performs predetermined controls and operations using various resources according to the instructions described in the programs loaded on the RAM 62, so that the functions of the units described above can be implemented on the software.

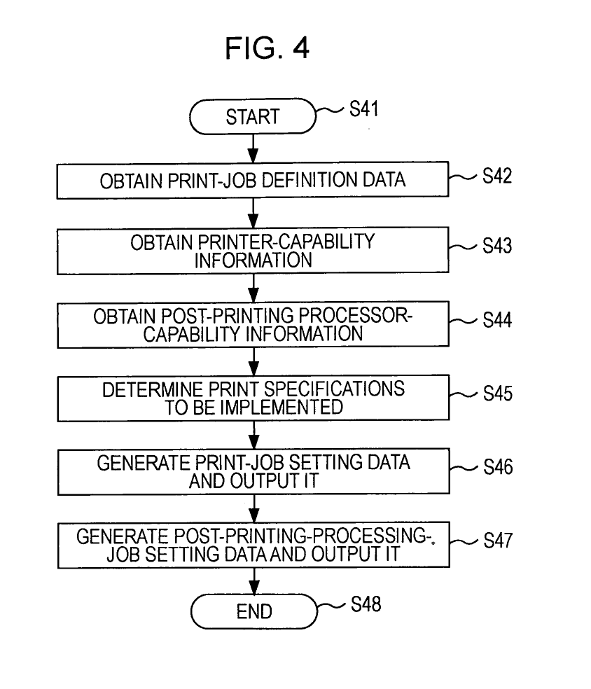

FIG. 4 is a flowchart for the process of the print support apparatus 10 according to the embodiment of the invention.

First, in step S41, the apparatus 10 is started, and in step S42, the print-job-definition-data input section 14 of the print support apparatus 10 obtains the print-job definition data Y. Next, the printer-capability-information acquisition section 17 obtains the printer capability information Z of the printer 20. Then, the post-printing processor-capability-information acquisition section 18 obtains the post-printing-processor capability information W of the post-printing processor.

Next, in step S45, the print-specification determination section 15 determines print specifications to be implemented according to the print-job definition data Y and the printer capability information Z thus obtained. In step S46, the print-specification determination section 15 generates print-job setting data Y′ according to the print specifications determined in step S46, and outputs the generated print-job setting data Y′ to the printer 20 via the print-job-setting-data output section 16.

In step S47, the print-specification determination section 15 generates post-printing-processing-job setting data W′ according to the print-job definition data Y and the post-printing-processor capability information W thus obtained, and outputs the generated post-printing-processing-job setting data W′ to the post-printing processor 30 via the post-printing-processing-job-setting-data output section 19.

After the print-job setting data Y′ is sent to the printer 20 and the post-printing-processing-job setting data W′ is sent to the post-printing processor 30 in that way, the operation of the print support apparatus 10 is terminated in step S48.

Step S46 and step S47 may be reversed to the order of step S47 and step S46.

The content data X′ processed by the content-data processing section 12 may be output to the printer 20, although not included in the foregoing procedure, at the same time when the print-job definition data is output to the printer 20 in step S46, or if the time of printing is staggered, the processed content data X′ may be output to the post-printing processor 30 when the post-printing-processing-job setting data We is output to the post-printing processor 30 in step S47.

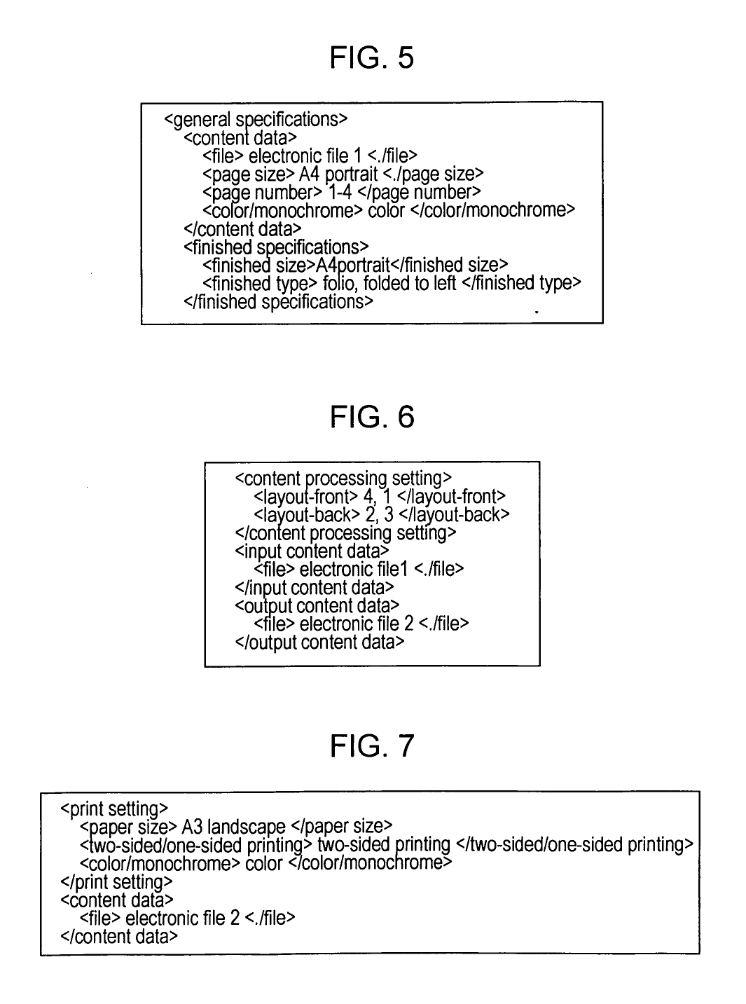

FIG. 5 is a diagram showing an example of the content data.

The content data X obtained by the content-data acquisition section 11 is set as follows:

<general specifications>
<content data>
<file> electronic file 1 <./file>
<page size> A4 portrait <./page size>
<page number> 1-4 <page number>
<color/monochrome> color </color/monochrome>
</content data>
<finished specifications>
<finished size> A4 portrait </finished size>
<finished type> folio, folded to left </finished type>
</finished specifications>

FIG. 6 is a diagram showing an example of the content-processing-information setting data.

The content-data processing section 12 processes the content data X using the content-processing-information setting data as shown in FIG. 6 to generate the processed content data X′.

The processed content data X′ is set as follows:

<content processing setting>
<layout-front> 4, 1 </layout-front>
<layout-back> 2, 3 </layout-back>
</content processing setting>
<input content data>
<file> electronic file 1 <./file>
</input content data>
<output content data>
<file> electronic file 2 <./file>
</output content data>

FIG. 7 is a diagram showing an example of the print-job setting data.

The print-specification determination section 15 converts print-job definition data Y to generate the print-job setting data Y′. This data is used in actual printing.

As shown in FIG. 7, the print-job setting data Y′ used for printing is set as follows:

```
  <print setting>
  <paper size> A3 landscape </paper size>
  <two-sided/one-sided printing> two-sided printing </two-
sided/one-sided printing>
  <color/monochrome> color </color/monochrome>
  </print setting>
  <content data>
  <file> electronic file 2 <./file>
  </content data>
```

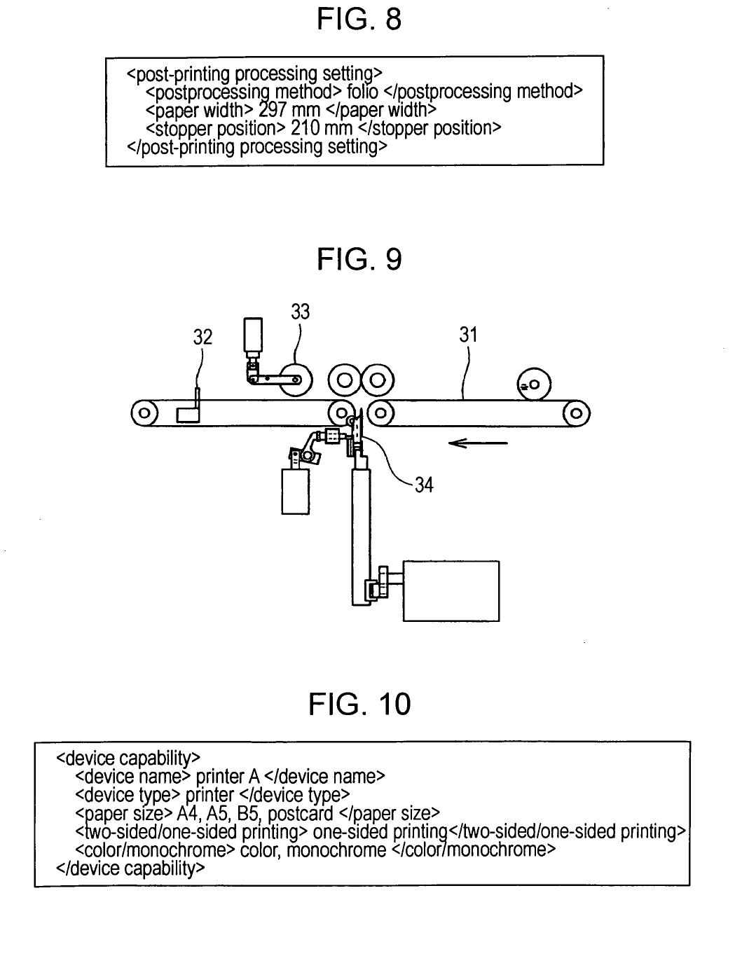

FIG. 8 is a diagram showing an example of the post-printing-processing setting data.

The print-specification determination section 15 generates the post-printing-processing-job setting data W′ according to the print-job definition data Y and the post-printing-postprocessor capability information W. The data is used in executing post-printing processing.

As shown in FIG. 8, the post-printing-processing-job setting data W′ is set as follows:

<post-printing-processing setting>
<postprocessing method> folio </postprocessing method>
<paper width> 297 mm </paper width>
<stopper position> 210 mm </stopper position>
</post-printing-processing setting>

The setting of this postprocessor is for a folding machine. Another postprocessor may adopt another setting.

The folding machine will be described.

FIG. 9 is a schematic diagram of the folding machine. This is a sectional view of the folding mechanism as viewed from one side with respect to the paper feed direction. Paper is placed onto a paper conveying belt 31 in the direction of the arrow. The paper is conveyed by the paper conveying belt 31 and a roller 33 until it comes into contact with a stopper 32, at which a knife 34 rises from below to fold the paper. “Stopper position” is determined such that the distance from the stopper 32 to the knife 34 is adjusted to the paper width. The item “paper width” is used to set the paper guide provided along the paper feed direction. That is, the paper guide is provided at two positions, the distance of which corresponds to the paper width. Thus, paper is conveyed on the paper conveying belt 31 without folding.

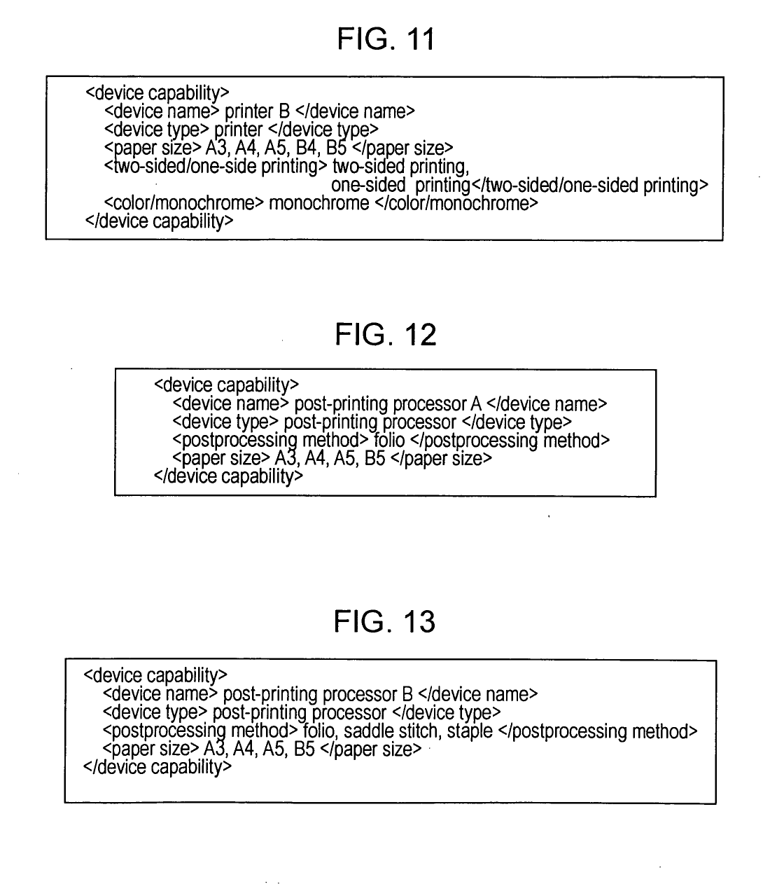

FIGS. 10 and 11 show printer capability information.

The printer capability information Z shown in FIG. 10 is set as follows:

```
      <device capability>
      <device name> printer A </device name>
      <device type> printer </device type>
      <paper size> A4, A5, B5, postcard </paper size>
      <two-sided/one-sided printing> two-sided printing </two-
sided/one-sided printing>
      <color/monochrome> color </color/monochrome>
      </device capability>
```

The printer capability information Z shown in FIG. 11 is set as follows:

```
      <device capability>
      <device name> printer B </device name>
      <device type> printer </device type>
      <paper size> A3, A4, A5, B4, B5 </paper size>
      <two-sided/one-sided printing> two-sided printing, one-
sided printing </two-sided/one-sided printing>
      <color/monochrome> monochrome </color/monochrome>
      </device capability>
```

FIGS. 12 and 13 show post-printing-processor capability information.

The post-printing-postprocessor capability information W shown in FIG. 12 is set as follows:

<device capability>
<device name> print postprocessor A </device name>
<device type> print postprocessor </device type>
<postprocessing method> folio </postprocessing method>
<paper size> A3, A4, A5, B5 </paper size>
</device capability>

The post-printing-postprocessor capability information W shown in FIG. 13 is set as follows:

```
      <device capability>
      <device name> print postprocessor B </device name>
      <device kind> print postprocessor </device kind>
      <postprocessing method> folio, saddle stitch, staple
</postprocessing method>
<paper size> A3, A4, A5, B5 </paper size>
</device capability>
```

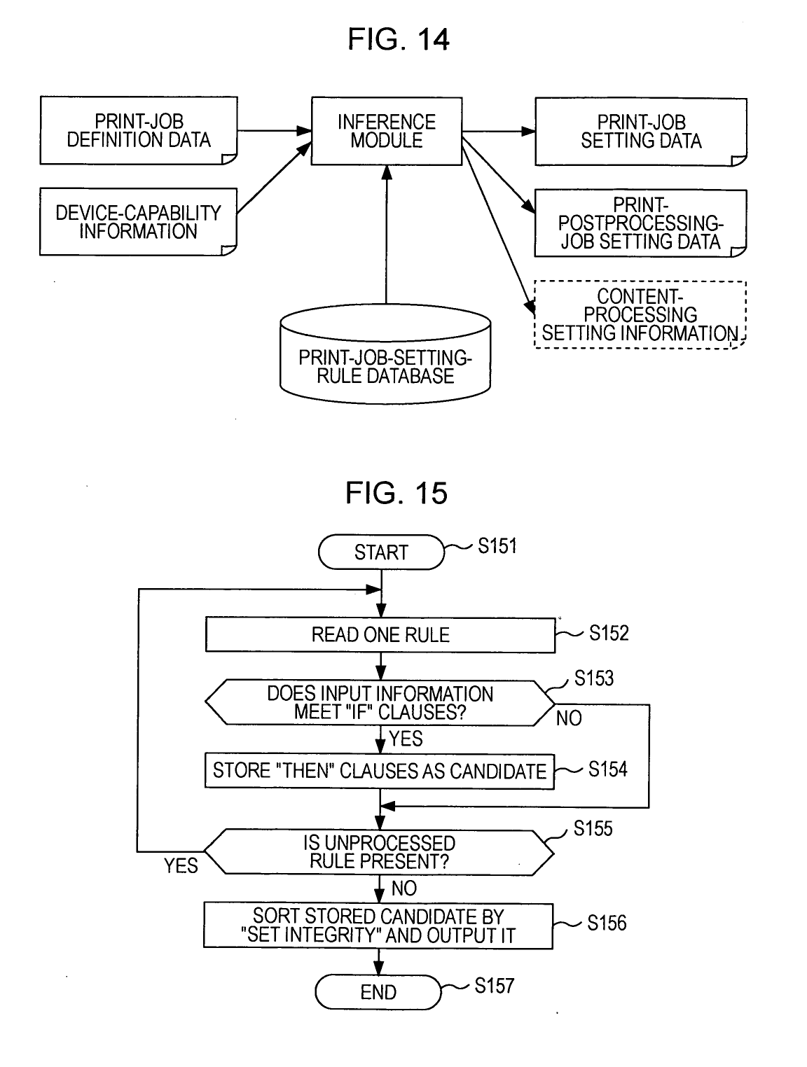

FIG. 14 is a block diagram showing the internal structure of a print-specification determination section.

The print-specification determination section 15 of the print support apparatus 10 according to this embodiment determines print specifications that can be implemented by an available device from the input print-job definition data and the obtained capability information on the printer and the post-printing processor to derive print settings and post-printing process settings. That is, the print-specification determination section 15 includes an inference module and a print-job-setting-rule database. The inference module generates print-job setting data and post-printing-process-job setting data from the input print-job definition data and the device capability information on the basis of the print-job-setting-rule database. The print-job-setting-rule database will be described later.

This inference of print specifications by the inference module allows the print-specification determination section 15 to determine print specifications easily with high reproducibility, because predetermined print-job setting rules are stored in the print-job-setting-rule database.

FIG. 15 is a flowchart for the process of the print-specification determination section 15.

In step S151, the apparatus 10 is started, then in step S152, the print-specification determination section 15 reads an appropriate print-job setting rule from the print-job-setting-rule database, and in step S153, the print-specification determination section 15 determines whether the input print-job definition data and device capability information meet the “if” clauses of the print-job setting rule. If the “if” clauses are met, the “then” closes are stored as a candidate for setting in step S154. If the candidate is stored in step S154 or if the input information does not meet the “if” clauses in step S153, the print-specification determination section 15 determines in step S155 whether or not an unprocessed rule is present. If an unprocessed rule is present, the print-specification determination section 15 returns to step S152, where it reads the rule and repeats the following process. If no unprocessed rule remains in step S155, the print-specification determination section 15 sorts the setting information stored in step S154 by “setting integrity” and outputs it in step S156, and terminates the process in step S157.

As discussed above, the print-job-setting-rule database has the conditional “if” clauses and the resulting “then” clauses. Therefore, applying only the conditional clauses leads its results. Thus, the print-specification determination section 15 can automatically determine print specifications.

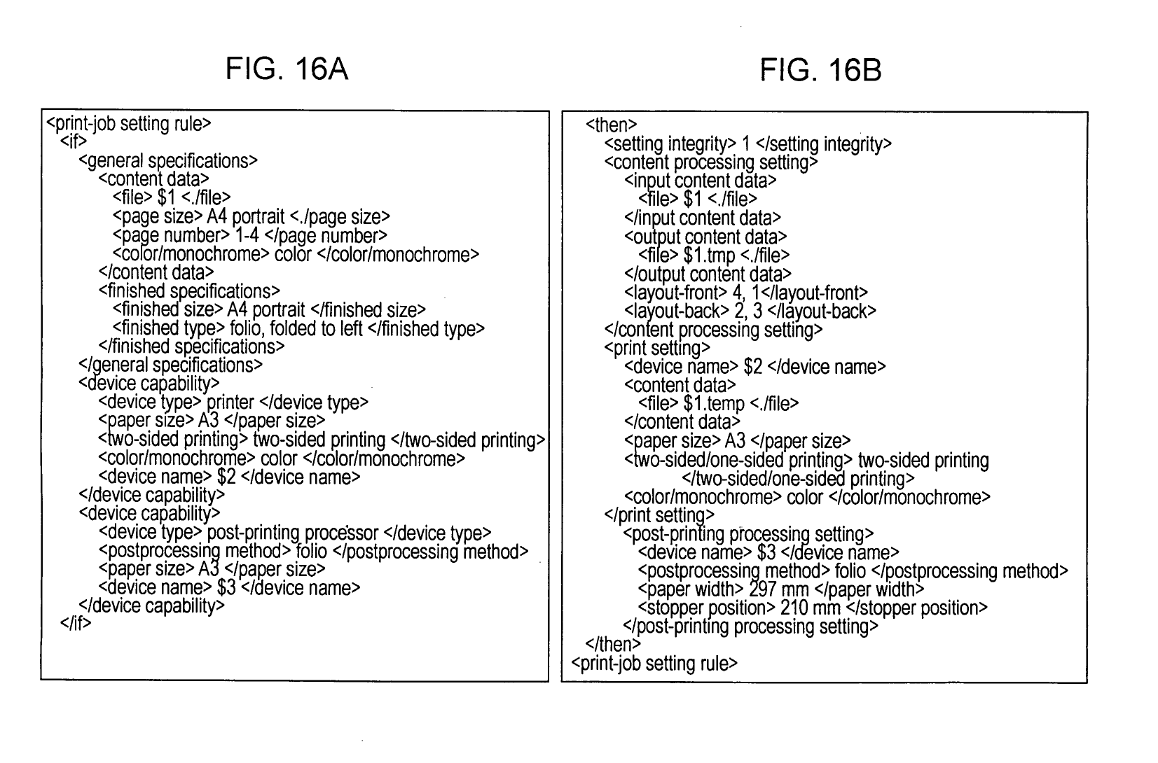

FIGS. 16A and 16B show an example (a first embodiment) of the print-job setting rule. FIG. 16A shows conditional clauses, or “if clauses”, and FIG. 16B shows “then” clauses.

The rule includes “general specifications”, “printer capability information”, and “post-printing-processor capability information”.

The “if” clauses shown in FIG. 16A are set as follows:

```
      <general specifications>
      <content data>
      <file> $1 <./file>
      <page size> A4 portrait <./page size>
      <color/monochrome> color </color/monochrome>
      </content data>
      <finished specifications>
      <finished size> A4 portrait </finished size>
      <finished type> folio, folded to left </finished type>
      </finished specifications>
      </general specifications>
      <device capability>
      <device type> printer </device type>
      <paper size> A3 </paper size>
      <two-sided/one-sided printing> two-sided </two-sided/one-
sided printing>
      <color/monochrome> color </color/monochrome>
      <device name> $2 </device name>
      </device capability>
      <device capability>
      <device type> post-printing processor </device type>
      <postprocessing method> folio </postprocessing method>
      <paper size> A3 </paper size>
      <device name> $3 </device name>
      </device capability>
```

The “then” clauses shown in FIG. 16B are set as follows:

```
      <setting integrity> 1 </setting integrity>
      <content processing setting>
      <input content data>
      <file> $1 <./file>
      </input content data>
      <output content data>
      <file> $1.tmp <./file>
      </output content data>
      <layout-front> 4, 1</layout-front>
      <layout-back> 2, 3 </layout-back>
      </content processing setting>
      <print setting>
      <device name> $2 </device name>
      <content data>
      <file> $1.temp </file>
      </content data>
      <paper size> A3 </paper size>
      <two-sided/one-sided printing> two-sided </two-sided/one-
sided printing>
      <color/monochrome> color </color/monochrome>
      </print setting>
      <post-printing-processing setting>
      <device name> $3 </device name>
      <postprocessing method> folio </postprocessing method>
      <paper width> 297 mm </paper width>
      <stopper position> 210 mm </stopper position>
      </post-printing-processing setting>
```

The print-job-setting-rule database stores multiple “if-then”format rules. Print specifications are thus determined with reference to such rules, and device settings for implementing the specifications are derived, as shown in the flowchart of FIG. 15.

In the rules, the consecutive “$” and numeral is a variable. For an undefined variable, the value of corresponding data is substituted, if undefined, into a true value for the “if” clause. If defined, the valuable is treated equally to the value.

Specifically, if compared with

<content data>
<file> $1 <./file>
<page size> A4 portrait <./page size>
<page number> 1-4 </page number>
<color/monochrome> color </color/monochrome>
</content data>

in the “if” clause of the print-job setting rules shown in FIG. 16A, “electronic file 1” is substituted for the variable $1. The subsequent “then” clause becomes:

<content processing setting>
<input content data>
<file> electronic file <./file>
</input content data>
<output content data>
<file> electronic file 1. tmp <./file>
</output content data>
<layout-front> 4, 1</layout-front>
<layout-back> 2, 3 </layout-back>
</content processing setting>

This applies also to $2 and $3. When two or more devices meet the device capability conditions in the “if” clauses, it is determined whether the respective devices meet the “if” clauses. That is, it is determined whether the “if” clauses hold in the case where $2 is a printer A and a printer B and the case where $3 is a post-printing processor A and a post-processing processor b. That is, in the process flow of the print-specification determination section 15, an internal loop is formed for step S153 of “does input information meet “if” clauses?”, and if the determination is “yes”, step S154 of “store “then” clause as a candidate for setting”, and is executed for each of the combinations of the devices.

In this embodiment, the “if” clauses of the rule are each an AND condition. That is, unless all the “if” clauses meet the input print-job definition data/obtained device capability information, the whole “if” clauses do not become true. In contrast, the print-job definition data/device capability information are OR conditions, so that not all of them need to meet the “if” clauses. Accordingly, the “if” clauses of this rule do not become true for the printer A and the printer B. This is because they are not ready for color A4-size printing.

Thus, “if” clauses are AND conditions. Therefore, unless all the “if” clauses meet the input print-job definition data and the obtained device capability information, the “if” clauses do not become true, so that print specifications are not determined, thus preventing unexpected troubles.

When two or more devices meet the device capability conditions in the “if” clauses of the “if-then” format, it is determined whether the respective devices meet the “if” clauses and then an inner loop is formed for a combination of the devices to determine whether the “if” clauses hold, and multiple times of processing are executed. Thus, examinations on all the available printers and post-printing processors provide the best results.

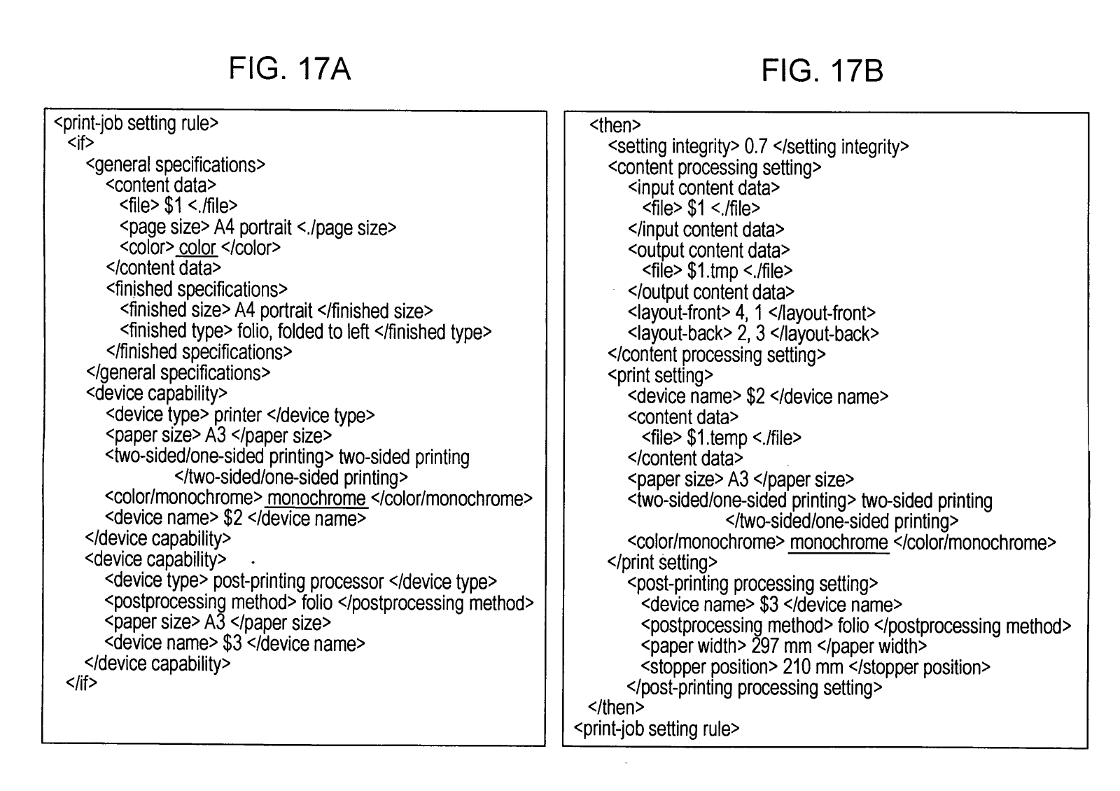

FIGS. 17A and 17B show an example (a second embodiment) of the print-job setting rules. FIG. 17A shows conditional clauses, or “if clauses”, and FIG. 17B shows “then” clauses.

The rule include “general specifications”, “printer capability information”, and “post-printing-processor capability information”.

The “if” clauses shown in FIG. 17A are set as follows:

```
      <general specifications>
      <content data>
      <file> $1 <./file>
      <page size> A4 portrait <./page size>
      <color/monochrome> color </color/monochrome>
      </content data>
      <finished specifications>
      <finished size> A4 portrait </finished size>
      <finished type> folio, folded to left </finished type>
      </finished specifications>
      </general specifications>
      <device capability>
      <device type> printer </device type>
      <paper size> A3 </paper size>
      <two-sided/one-sided printing> two-sided </two-sided/one-
sided printing>
      <color/monochrome> monochrome </color/monochrome>
      <device name> $2 </device name>
      </device capability>
      <device capability>
      <device type> post-printing processor </device type>
      <postprocessing method> folio </postprocessing method>
      <paper size> A3 </paper size>
      <device name> $3 </device name>
      </device capability>
```

The “then” clauses shown in FIG. 17B are set as follows:

```
      <setting integrity> 0.7 </setting integrity>
      <content processing setting>
      <input content data>
      <file> $1 <./file>
      </input content data>
      <output content data>
      <file> $1.tmp <./file>
      </output content data>
      <layout-front> 4, 1 </layout-front>
      <layout-back> 2, 3 </layout-back>
      </content processing setting>
      <print setting>
      <device name> $2 </device name>
      <content data>
      <file> $1.temp <./file>
      </content data>
      <paper size> A3 </paper size>
      <two-sided/one-sided printing> two-sided </two-sided/one-
sided printing>
      <color/monochrome> monochrome </color/monochrome>
      </print setting>
      <post-printing-processing setting>
      <device name> $3 </device name>
      <postprocessing method> folio </postprocessing method>
      <paper width> 297 mm </paper width>
      <stopper position> 210 mm </stopper position>
      </post-printing-processing setting>
```

The second embodiment is similar in print job, printer, and post-printing process to the first embodiment of FIGS. 16A and 16B. Suppose there is a rule to print in A3-size paper with a monochrome printer and fold it into two by a postprocessor. This rule is to print in monochrome with an A3 monochrome printer although the content data of the input print job indicates color printing. This rule does not fully meet the print job specifications but allows acceptable printing. Thus, the setting integrity is set at “0.7”.

The content processing setting of this embodiment is not in job-definition data format because it is processed inside. However, if external content processing means is provided, it may be output as job definition data.

To print the processed content data, print-job definition data is generated and output via a print-job-definition-data data output section.

If color content data is input to a monochrome printer and it is printed in monochrome by appropriate process of the printer, the data can be converted by content processing means.

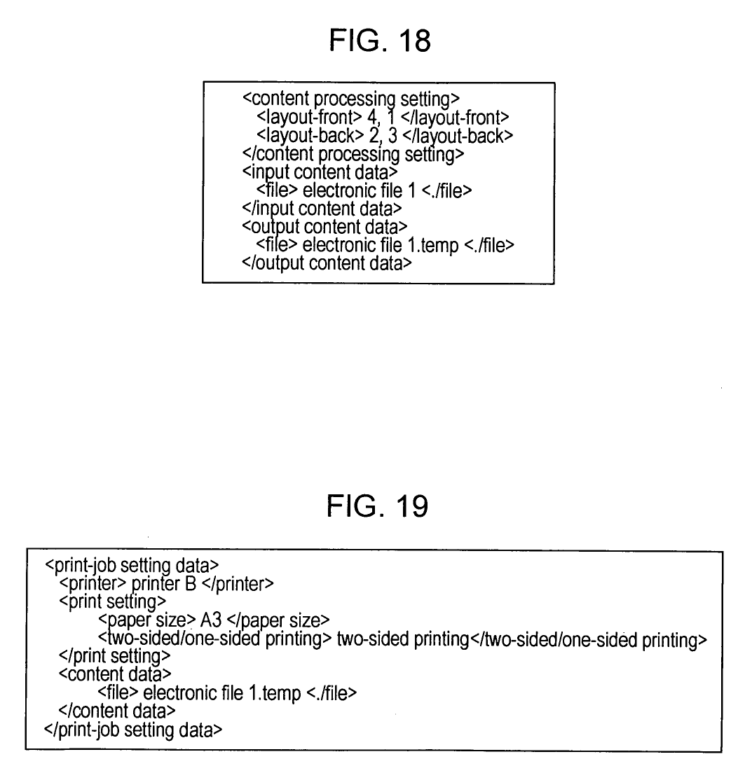

FIG. 18 is a diagram showing an example of the content-processing setting data.

The content-processing setting data is set as follows:

<content processing setting>
<layout-front> 4, 1 </layout-front>
<layout-back> 2, 3 </layout-back>
</content processing setting>
<input content data>
<file> electronic file 1 <./file>
</input content data>
<output content data>
<file> electronic file 1. temp <./file>
</output content data>

FIG. 19 is a diagram showing an example of the print-job setting data.

The print-job setting data is set as follows:

```
      <print-job setting data>
      <printer> printer B </printer>
      <print setting>
      <paper size> A3 </paper size>
      <two-sided/one-sided printing> two-sided </two-sided/one-
sided printing>
      </print setting>
      <content data>
      <file> electronic file 1.temp <./file>
      </content data>
      </print-job setting data>
```

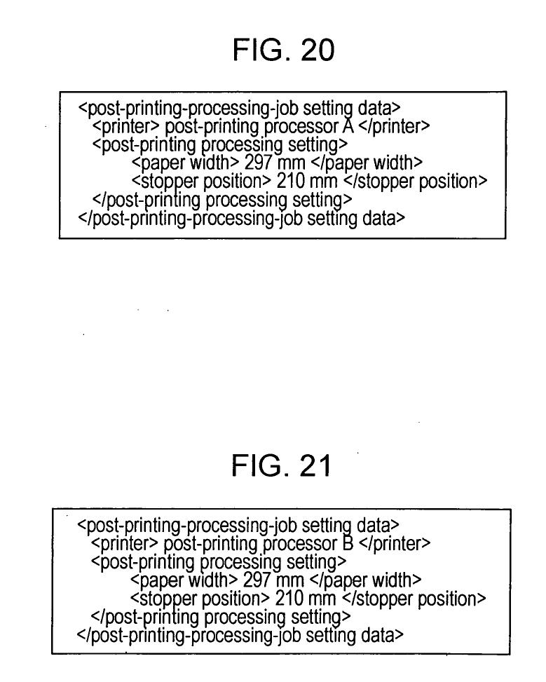

FIG. 20 is a diagram showing an example of post-printing-processing-job setting data.

An example of the post-printing-processing-job setting data W′ is set as follows:

<post-printing-processing-job setting data>
<printer> post-printing processor A </printer>
<post-printing-processing setting>
<paper width> 297 mm </paper width>
<stopper position> 210 mm </stopper position>
</post-printing-processing setting>
</post-printing-processing-job setting data>

FIG. 21 is a diagram showing another example of the post-printing-processing-job setting data.

Another example of the post-printing-processing-job setting data W′ is set as follows:

<post-printing-processing-job setting data>
<printer> post-printing processor B </printer>
<post-printing-processing setting>
<paper width> 297 mm </paper width>
<stopper position> 210 mm </stopper position>
</post-printing-processing setting>

</post-printing-processing-job setting data>

In this embodiment, the process of folding A3 paper in two can be executed by either of the post-printing processors A and B. Therefore, two types of post-printing-processing-job setting data W′ can be output for the post-printing processors A and B.

The process flow for implementing print specifications can be automatically searched for, depending on the combination of available printer and post-printing processor, and thus print-job setting data corresponding to the devices can be generated.

Even if the print specifications cannot be implemented because of the limitations in the capability of the printer and the post-printing processor, alternative print specifications that meet the print specifications as much as possible can be determined for printing.

Thus, even if the print specifications cannot be implemented because of the limitations in the capability of the printer and the post-printing processor, the print-specification determination section 15 determines alternative print specifications close to the print specifications to allow close-to-objective printing.

Since content data is processed appropriately to implement alternative print specifications, there is no need for the operator to process the content data.

The post-printing process includes paper collation, bookbinding (staple, side stitch, saddle stitch, adhesive binding, and superior binding), folding (in two, three, four, accordion binding, Z-fold, and cross fold), creasing, cutting, punching, lamination, packing, and transportation. The post-printing process can include setting information necessary for execution by a post-printing processor, for example, Job Definition Format (JDF) by International Cooperation of for the Integration of Processing in Prepress, Press and Postpress (CIP4).

Accordingly, since almost all post-printing processes including paper collation, stitching, bookbinding, folding, packing, and transportation are addressed, the use of a combination of such post-printing processors allows post-printing processors to be automatically selected, thus allowing substantially perfect post-printing processing.

For the execution of the flowchart of FIG. 4, a control program stored in a ROM is used. As an alternative, a program for the procedure recorded in a storage medium may be incorporated into a RAM for execution, or the program may be obtained via a network.

Here, examples of the storage medium are semiconductor storage media such as RAMs and ROMs, magnetic storage media such as FDs and HDs, optical readout storage media such as CDs, CDVs, LDs, and DVDS, and magnetic recording/optical readout storage media such as MOs, or all computer-readable storage media irrespective of whether the method of reading is electronic, magnetic, or optical.

Although the invention has been described with reference to the preferred embodiments, it is to be understood that the invention is not limited to the embodiments and various modifications may be made without departing from the spirit and scope of the invention.

For example, as shown in the flowchart of FIG. 4, after printer capability information is obtained in step S43, post-printing-processor capability information is obtained in step S44. As an alternative, after the post-printing-processor capability information is obtained, then the printer capability information may be obtained. This also applies to the output in step S46 and step S47.

### Form 1

A print support apparatus of Form 1 includes: a print-job-definition-data input section that receives input of print-job definition data describing print specifications; a printer-capability-information acquisition section that obtains capability information on an available printer; a post-printing-processor-capability-information acquisition section that obtains capability information on an available post-printing processor; a print-specification determination section that determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section, and generates print-job setting data describing print settings for executing printing according to the print specifications and post-printing-process-job setting data describing post-printing-process settings for executing postprocessing of a print medium printed according to the print specifications; a print-job-setting output section that outputs the print-job setting data generated by the print-specification determination section; and a post-printing-processing-job-setting output section that outputs the post-printing-process-job setting data generated by the print-specification determination section.

With the arrangement, after the printer-capability-information acquisition section obtains capability information on an available printer, and the post-printing-processor-capability-information acquisition section obtains capability information on an available post-printing processor, the print-specification determination section determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section. The print support apparatus thus generates print-job setting data describing print settings for executing printing according to the print specifications and post-printing-process-job setting data describing post-printing-process settings for executing postprocessing of a print medium printed according to the print specifications. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated.

### Form 2

A print support apparatus of Form 2 includes: a print-job-definition-data input section that receives input of print-job definition data describing print specifications; a printer-capability-information acquisition section that obtains capability information on an available printer; a post-printing-processor-capability-information acquisition section that obtains capability information on an available post-printing processor; a content-data acquisition section that obtains content data associated with the print-job definition data received by the print-job-definition-data input section; a print-specification determination section that determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section, and generates print-job setting data describing print settings for executing printing according to the print specifications and post-printing-process-job setting data describing post-printing-process settings for executing postprocessing of a print medium printed according to the print specifications; a content-data processing section that processes the content data obtained by the content-data acquisition section according to the print specifications determined by the print-specification determination section; a print-job-setting output section that outputs the print-job setting data generated by the print-specification determination section; a post-printing-processing-job-setting output section that outputs the post-printing-process-job setting data generated by the second generation section; a print instruction section that instructs a printer to print the content data processed by the content-data processing section according to the description of the print-job setting data output from the print-job-setting-data output section; and a post-printing-process instruction section that instructs a post-printing processor to execute postprocessing of the print medium printed by the printer according to the description of the post-printing-process-job setting data output from the post-printing-process-job-setting-data output section.

With the arrangement, after the printer-capability-information acquisition section obtains capability information on an available printer, and the post-printing-processor-capability-information acquisition section obtains capability information on an available post-printing processor, the print-specification determination section determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section. The print support apparatus thus generates print-job setting data describing print settings for executing printing according to the print specifications and post-printing-process-job setting data describing post-printing-process settings for executing postprocessing of a print medium printed according to the print specifications. The content-data acquisition section obtains content data associated with the print-job definition data received by the print-job-definition-data input section. The content-data processing section processes the content data obtained by the content-data acquisition section according to the print specifications determined by the print-specification determination section. The print instruction section instructs a printer to print the content data processed by the content-data processing section according to the description of the print-job setting data output from the print-job-setting-data output section. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated. Moreover, since the content data is processed appropriately by the content-data processing section, there is no need for processing the content data manually.

### Form 3

In Form 3, the print support apparatus of Form 1 or 2 may be configured such that the print-specification determination section includes: an inference module that infers print specifications to be implemented, from the print-job definition data, the printer capability information, and the post-printing-processor capability information on the basis of the print-job-setting-rule database and a print-job-setting-rule database that stores predetermined print-job setting rules for the inference module.

With this arrangement, print specifications to be implemented can be inferred by the inference module, and predetermined print-job-setting rules are stored in the print-job-setting-rule database. This offers the advantage that the print-specification determination section can determine print specifications easily with high reproducibility.

### Form 4

In Form 4, the print support apparatus of Form 3 may be configured such that the print-job-setting-rule database stores if-then format rules.

In this arrangement, the print-job-setting-rule database includes conditional “if” clauses and resulting “then” clauses. Therefore, when only the conditional clauses are applied, its results are derived. Therefore, the print-specification determination section can automatically determine the print specifications.

### Form 5

In Form 5, the print support apparatus of Form 4 may be configured such that the “if” clauses are each an AND condition. Unless all of “if” clauses meet the input print-job definition data and the obtained device capability information, the “if” clauses do not become true.

In this arrangement, the “if” clauses are each an AND condition. Therefore, unless all of the “if” clauses meet the input print-job definition data and the obtained device capability information, the “if” clauses do not become true, so that print specifications are not determined. This offers the advantage of preventing unexpected troubles.

### Form 6

In Form 6, the print support apparatus of Form 4 or 5 may be configured such that if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed.

In this arrangement, if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed. This offers the advantage of deriving the best results by examining all the available printers and post-printing processors.

### Form 7

In Form 7, the print support apparatus of one of Forms 1 to 6 may be configured such that if print specifications cannot be implemented because of restrictions of the printer or the post-printing processor, the print-specification determination section outputs zero or more alternative print specifications.

In this arrangement, if print specifications cannot be implemented because of restrictions of the printer or the post-printing processor, the print-specification determination section outputs zero or more alternative print specifications. Therefore, for other than job definition data having no alternative, the print-specification determination section outputs two or more candidates of alternative print specifications close to the print specifications so that the user can select print specifications from the candidates.

### Form 8

In Form 8, the print support apparatus of Form 7 may be configured such that the alternative print specifications include information indicative how much the print specifications to be implemented meet the input print-job definition data.

In this arrangement, the alternative print specifications include information indicative how much the print specifications to be implemented meet the input print-job definition data. This offers the advantage of facilitating evaluation of the alternative print specifications.

### Form 9

In Form 9, the print support apparatus of one of Forms 1 to 8 may be configured such that the postprocessing of the print medium includes paper collation, stitching, bookbinding, folding, packing, and transportation.

In this arrangement, post-printing processors can execute almost all post-printing processing, such as paper collation, stitching, bookbinding, folding, packing, and transportation. This offers the advantage that the use of a combination of post-printing processors allows substantially perfect post-printing processing.

### Form 10

A method for supporting printing in Form 10 includes:

receiving input of print-job definition data describing print specifications; obtaining capability information on an available printer; obtaining capability information on an available post-printing processor; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; outputting the print-job setting data generated in the print-specification determination step; and outputting the post-printing-process-job setting data generated in the print-specification determination step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition section, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Thus, printing and post-printing processing can be executed according to the print-job definition data and the obtained printer capability information and post-printing-processor capability information, or print specifications changed as necessary. Moreover, print-job setting data can be generated according to the changed print specifications. Thus the process for implementing print specifications can be automatically searched for with the combination of an available printer and postprocessor, and print-job setting data corresponding to the respective devices can be generated.

### Form 11

A print support method of Form 11 includes: receiving input of print-job definition data describing print specifications; obtaining capability information on an available printer; obtaining capability information on an available post-printing processor; obtaining content data associated with the print-job definition data received in the print-job-definition-data input step; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; processing the content data obtained by the content-data acquisition section according to the print specifications determined in the print-specification determination step; outputting the print-job setting data generated in the print-specification determination step; outputting the post-printing-process-job setting data generated in the print-specification determination step; instructing a printer to print the content data processed in the content-data processing step according to the description of the print-job setting data output in the print-job-setting-data output step; and instructing a post-printing processor to execute postprocessing of the print medium printed by the printer according to the description of the post-printing-process-job setting data output in the post-printing-process-job-setting-data output step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition step, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Content data associated with the print-job definition data received in the print-job-definition-data input step is obtained in the content-data acquisition step; and the content data obtained in the content-data acquisition step is processed in the content-data processing step according to the print specifications determined in the print-specification determination step; and in the print instruction step, the printer is instructed to print the content data processed in the content-data processing step according to the description of the print-job setting data output in the print-job-setting-data output step. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated. Moreover, since the content data is processed appropriately by the content-data processing section, there is no need for processing the content data manually.

### Form 12

In Form 12, the print support method of Form 10 or 11 may be configured such that the print-specification determination step includes: an inference module that infers print specifications from the print-job definition data, the printer capability information, and the post-printing-processor capability information and a print-job-setting-rule database that stores predetermined print-job setting rules for the inference module.

This arrangement offers the same advantage as Form 2.

### Form 13

In Form 13, the print support method of Form 12 may be configured such that the print-job-setting-rule database stores if-then format rules.

In this arrangement, the print-job-setting-rule database includes conditional “if” clauses and resulting “then” clauses. Therefore, when only the conditional clauses are applied, its results are derived. Therefore, the print-specification determination step allows print specifications to be determined automatically.

### Form 14

In Form 14, the print support method of Form 13 may be configured such that the “if” clauses are each an AND condition. Unless all of “if” clauses meet the input print-job definition data and the obtained device capability information, the “if” clauses do not become true.

### Form 15

In Form 15, the print support method of Form 13 or 14 may be configured such that if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed.

In this arrangement, if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed. This offers the advantage of deriving the best results by examining all the available printers and post-printing processors.

### Form 16

In Form 16, the print support method of one of Forms 10 to 15 may be configured such that if print specifications cannot be implemented because of restrictions of the printer or the post-printing processor, the print-specification determination step outputs zero or more alternative print specifications.

In this arrangement, if print specifications cannot be implemented because of restrictions of the printer or the post-printing processor, the print-specification determination section outputs zero or more alternative print specifications. Therefore, for other than job definition data having no alternative, the print-specification determination section outputs two or more candidates of alternative print specifications close to the print specifications so that the user can select print specifications from the candidates.

### Form 17

In Form 17, the print support method of Form 16 may be configured such that the alternative print specifications include information indicative how much the print specifications to be implemented meet the input print-job definition data.

In this arrangement, the alternative print specifications include information indicative how much the print specifications to be implemented meet the input print-job definition data. This offers the advantage of facilitating evaluation of the alternative print specifications.

### Form 18

In Form 18, the print support method of one of Forms 10 to 17 may be configured such that the post-printing process includes paper collation, stitching, bookbinding, folding, packing, and transportation.

In this arrangement, post-printing processors can execute almost all post-printing processing, such as paper collation, stitching, bookbinding, folding, packing, and transportation. This offers the advantage that the use of a combination of post-printing processors allows substantially perfect post-printing processing.

### Form 19

A print support program of Form 19 includes receiving input of print-job definition data describing print specifications; obtaining capability information on an available printer; obtaining capability information on an available post-printing processor; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; outputting the print-job setting data generated in the print-specification determination step; and outputting the post-printing-process-job setting data generated in the print-specification determination step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition section, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Thus, printing and post-printing processing can be executed according to the print-job definition data and the obtained printer capability information and post-printing-processor capability information, or print specifications changed as necessary. Moreover, print-job setting data can be generated according to the changed print specifications. Thus the process for implementing print specifications can be automatically searched for with the combination of an available printer and postprocessor, and print-job setting data corresponding to the respective devices can be generated.

### Form 20

A print support program of Form 20 includes: receiving input of print-job definition data describing print specifications; obtaining capability information on an available printer; obtaining capability information on an available post-printing processor; obtaining content data associated with the print-job definition data received in the print-job-definition-data input step; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; processing the content data obtained by the content-data acquisition section according to the print specifications determined in the print-specification determination step; outputting the print-job setting data generated in the print-specification determination step; outputting the post-printing-process-job setting data generated in the print-specification determination step; instructing a printer to print the content data processed in the content-data processing step according to the description of the print-job setting data output in the print-job-setting-data output step; and instructing a post-printing processor to execute postprocessing of the print medium printed by the printer according to the description of the post-printing-process-job setting data output in the post-printing-process-job-setting-data output step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition step, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Content data associated with the print-job definition data received in the print-job-definition-data input step is obtained in the content-data acquisition step; and the content data obtained in the content-data acquisition step is processed in the content-data processing step according to the print specifications determined in the print-specification determination step; and in the print instruction step, the printer is instructed to print the content data processed in the content-data processing step according to the description of the print-job setting data output in the print-job-setting-data output step. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated. Moreover, since the content data is processed appropriately by the content-data processing section, there is no need for processing the content data manually.

### Form 21

In Form 21, the print support program of Form 19 or 20 may be configured such that the print-specification determination step includes: an inference module that infers print specifications from the print-job definition data, the printer capability information, and the post-printing-processor capability information and a print-job-setting-rule database that stores predetermined print-job setting rules for the inference module.

With this arrangement, print specifications to be implemented can be inferred by the inference module, and predetermined print-job-setting rules are stored in the print-job-setting-rule database. Thus, in the print-specification determination step, print specifications can easily be determined with high reproducibility.

### Form 22

In Form 22, the print support program of Form 21 may be configured such that the print-job-setting-rule database stores if-then format rules.

In this arrangement, the print-job-setting-rule database includes conditional “if” clauses and resulting “then” clauses. Therefore, when only the conditional clauses are applied, its results are derived. Therefore, the print-specification determination step allows print specifications to be determined automatically.

### Form 23

In Form 23, the print support program of Form 22 may be configured such that the “if” clauses are each an AND condition. Unless all of “if” clauses meet the input print-job definition data and the obtained device capability information, the “if” clauses do not become true.

In this arrangement, the “if” clauses are each an AND condition. Therefore, unless all of the “if” clauses meet the input print-job definition data and the obtained device capability information, the “if” clauses do not become true, so that print specifications are not determined. This offers the advantage of preventing unexpected troubles.

### Form 24

In Form 24, the print support program of Form 23 may be configured such that if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed.

In this arrangement, if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed. This offers the advantage of deriving the best results by examining all the available printers and post-printing processors.

### Form 25

In Form 25, the print support program of one of Forms 19 to 24 may be configured such that if print specifications cannot be implemented because of restrictions of the printer or the post-printing processor, the print-specification determination step outputs zero or more alternative print specifications.

In this arrangement, if print specifications cannot be implemented because of restrictions of the printer or the post-printing processor, the print-specification determination section outputs zero or more alternative print specifications. Therefore, for other than job definition data having no alternative, the print-specification determination section outputs two or more candidates of alternative print specifications close to the print specifications so that the user can select print specifications from the candidates.

### Form 26

In Form 26, the print support program of Form 25 may be configured such that the alternative print specifications include information indicative how much the print specifications to be implemented meet the input print-job definition data.

In this arrangement, the alternative print specifications include information indicative how much the print specifications to be implemented meet the input print-job definition data. This offers the advantage of facilitating evaluation of the alternative print specifications.

### Form 27

In Form 27, the print support program of one of Forms 19 to 26 may be configured such that the post-printing process includes paper collation, stitching, bookbinding, folding, packing, and transportation.

In this arrangement, post-printing processors can execute almost all post-printing processing, such as paper collation, stitching, bookbinding, folding, packing, and transportation. This offers the advantage that the use of a combination of post-printing processors allows substantially perfect post-printing processing.

### Form 28

A print system of Form 28 includes: a print-job-definition-data input section that receives input of print-job definition data describing print specifications; a printer-capability-information acquisition section that obtains capability information on an available printer; a post-printing-processor-capability-information acquisition section that obtains capability information on an available post-printing processor; a print-specification determination section that determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section, and generates print-job setting data describing print settings for executing printing according to the print specifications and post-printing-process-job setting data describing post-printing-process settings for executing postprocessing of a print medium printed according to the print specifications; a print-job-setting-data output section that outputs the print-job setting data generated by the print-specification determination section; and a post-printing-process-job-setting-data output section that outputs the post-printing-process-job setting data generated by the print-specification determination section.

With the arrangement, after the printer-capability-information acquisition section obtains capability information on an available printer, and the post-printing-processor-capability-information acquisition section obtains capability information on an available post-printing processor, the print-specification determination section determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section. The print support apparatus thus generates print-job setting data describing print settings for executing printing according to the print specifications and post-printing-process-job setting data describing post-printing-process settings for executing postprocessing of a print medium printed according to the print specifications. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated.

### Form 29

A print system of Form 29 includes: a print-job-definition-data input section that receives input of print-job definition data describing print specifications; a printer-capability-information acquisition section that obtains capability information on an available printer; a post-printing-processor-capability-information acquisition section that obtains capability information on an available post-printing processor; a content-data acquisition section that obtains content data associated with the print-job definition data received by the print-job-definition-data input section; a print-specification determination section that determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section, and generates print-job setting data describing print settings for executing printing according to the print specifications and post-printing-process-job setting data describing post-printing-process settings for executing postprocessing of a print medium printed according to the print specifications; a content-data processing section that processes the content data obtained by the content-data acquisition section according to the print specifications determined by the print-specification determination section; a print-job-setting output section that outputs the print-job setting data generated by the print-specification determination section; a post-printing-processing-job-setting output section that outputs the post-printing-process-job setting data generated by the second generation section; a print instruction section that instructs a printer to print the content data processed by the content-data processing section according to the description of the print-job setting data output from the print-job-setting-data output section; and a post-printing-process instruction section that instructs a post-printing processor to execute postprocessing of the print medium printed by the printer according to the description of the post-printing-process-job setting data output from the post-printing-process-job-setting-data output section.

With the arrangement, after the printer-capability-information acquisition section obtains capability information on an available printer, and the post-printing-processor-capability-information acquisition section obtains capability information on an available post-printing processor, the print-specification determination section determines print specifications to be implemented, according to the print specifications described in the print-job definition data received by the print-job-definition-data input section, the printer capability information obtained by the printer-capability-information acquisition section, and the post-printing-processor capability information obtained by the post-printing-processor-capability-information acquisition section. The print support apparatus thus generates print-job setting data describing print settings for executing printing according to the print specifications and post-printing-process-job setting data describing post-printing-process settings for executing postprocessing of a print medium printed according to the print specifications. The content-data acquisition section obtains content data associated with the print-job definition data received by the print-job-definition-data input section. The content-data processing section processes the content data obtained by the content-data acquisition section according to the print specifications determined by the print-specification determination section. The print instruction section instructs a printer to print the content data processed by the content-data processing section according to the description of the print-job setting data output from the print-job-setting-data output section. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated. Moreover, since the content data is processed appropriately by the content-data processing section, there is no need for processing the content data manually.

### Form 30

In Form 30, the print system of Form 28 or 29 may be configured such that the print-specification determination section includes: an inference module that infers print specifications to be implemented, from the print-job definition data, the printer capability information, and the post-printing-processor capability information on the basis of the print-job-setting-rule database and a print-job-setting-rule database that stores predetermined print-job setting rules for the inference module.

With this arrangement, print specifications to be implemented can be inferred by the inference module, and predetermined print-job-setting rules are stored in the print-job-setting-rule database. This offers the advantage that the print-specification determination section can determine print specifications easily with high reproducibility.

### Form 31

In Form 31, the print system of Form 30 may be configured such that the print-job-setting-rule database stores if-then format rules.

In this arrangement, the print-job-setting-rule database includes conditional “if” clauses and resulting “then” clauses. Therefore, when only the conditional clauses are applied, its results are derived. Therefore, the print-specification determination section can automatically determine the print specifications.

### Form 32

In Form 32, the print system of Form 31 may be configured such that the “if” clauses are each an AND condition. Unless all of “if” clauses meet the input print-job definition data and the obtained device capability information, the “if” clauses do not become true.

In this arrangement, the “if” clauses are each an AND condition. Therefore, unless all of the “if” clauses meet the input print-job definition data and the obtained device capability information, the “if” clauses do not become true, so that print specifications are not determined. This offers the advantage of preventing unexpected troubles.

### Form 33

In Form 33, the print system of Form 31 or 32 may be configured such that if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed.

In this arrangement, if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed. This offers the advantage of deriving the best results by examining all the available printers and post-printing processors.

### Form 34

In Form 34, the print system of one of Forms 25 to 33 may be configured such that if print specifications cannot be implemented because of restrictions of the printer or the post-printing processor, the print-specification determination section outputs zero or more alternative print specifications.

In this arrangement, if print specifications cannot be implemented because of restrictions of the printer or the post-printing processor, the print-specification determination section outputs zero or more alternative print specifications. Therefore, for other than job definition data having no alternative, the print-specification determination section outputs two or more candidates of alternative print specifications close to the print specifications so that the user can select print specifications from the candidates.

### Form 35

In Form 35, the print system of Form 34 may be configured such that the alternative print specifications include information indicative how much the print specifications to be implemented meet the input print-job definition data.

In this arrangement, the alternative print specifications include information indicative how much the print specifications to be implemented meet the input print-job definition data. This offers the advantage of facilitating evaluation of the alternative print specifications.

### Form 36

In Form 36, the print support apparatus of one of Forms 28 to 35 may be configured such that the postprocessing of the print medium includes paper collation, stitching, bookbinding, folding, packing, and transportation.

In this arrangement, post-printing processors can execute almost all post-printing processing, such as paper collation, stitching, bookbinding, folding, packing, and transportation. This offers the advantage that the use of a combination of post-printing processors allows substantially perfect post-printing processing.

### Form 37

A print method of Form 37 includes: receiving input of print-job definition data describing print specifications; obtaining capability information on an available printer; obtaining capability information on an available post-printing processor; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; outputting the print-job setting data generated in the print-specification determination step; and outputting the post-printing-process-job setting data generated in the print-specification determination step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition section, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Thus, printing and post-printing processing can be executed according to the print-job definition data and the obtained printer capability information and post-printing-processor capability information, or print specifications changed as necessary. Moreover, print-job setting data can be generated according to the changed print specifications. Thus the process for implementing print specifications can be automatically searched for with the combination of an available printer and postprocessor, and print-job setting data corresponding to the respective devices can be generated.

### Form 38

A print method of Form 38 includes: receiving input of print-job definition data describing print specifications; obtaining capability information on an available printer; obtaining capability information on an available post-printing processor; obtaining content data associated with the print-job definition data received in the print-job-definition-data input step; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; processing the content data obtained by the content-data acquisition section according to the print specifications determined in the print-specification determination step; outputting the print-job setting data generated in the print-specification determination step; outputting the post-printing-process-job setting data generated in the print-specification determination step; instructing a printer to print the content data processed in the content-data processing step according to the description of the print-job setting data output in the print-job-setting-data output step; and instructing a post-printing processor to execute postprocessing of the print medium printed by the printer according to the description of the post-printing-process-job setting data output in the post-printing-process-job-setting-data output step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition step, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Content data associated with the print-job definition data received in the print-job-definition-data input step is obtained in the content-data acquisition step; and the content data obtained in the content-data acquisition step is processed in the content-data processing step according to the print specifications determined in the print-specification determination step; and in the print instruction step, the printer is instructed to print the content data processed in the content-data processing step according to the description of the print-job setting data output in the print-job-setting-data output step. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated. Moreover, since the content data is processed appropriately by the content-data processing section, there is no need for processing the content data manually.

### Form 39

In Form 39, the print method of Form 37 or 38 may be configured such that the print-specification determination step includes: an inference module that infers print specifications from the print-job definition data, the printer capability information, and the post-printing-processor capability information and a print-job-setting-rule database that stores predetermined print-job setting rules for the inference module.

This arrangement offers the same advantage as Form 29.

### Form 40

In Form 40, the print method of Form 39 may be configured such that the print-job-setting-rule database stores if-then format rules.

In this arrangement, the print-job-setting-rule database includes conditional “if” clauses and resulting “then” clauses. Therefore, when only the conditional clauses are applied, its results are derived. Therefore, the print-specification determination step allows print specifications to be determined automatically.

### Form 41

In Form 41, the print method of Form 40 may be configured such that the “if” clauses are each an AND condition. Unless all of “if” clauses meet the input print-job definition data and the obtained device capability information, the “if” clauses do not become true.

In this arrangement, the “if” clauses are each an AND condition. Therefore, unless all of the “if” clauses meet the input print-job definition data and the obtained device capability information, the “if” clauses do not become true, so that print specifications are not determined. This offers the advantage of preventing unexpected troubles.

### Form 42

In Form 42, the print method of Form 40 or 41 may be configured such that if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed.

In this arrangement, if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed. This offers the advantage of deriving the best results by examining all the available printers and post-printing processors.

### Form 43

In Form 43, the print support method of one of Forms 33 to 42 may be configured such that if print specifications cannot be implemented because of restrictions of the printer or the post-printing processor, the print-specification determination step outputs zero or more alternative print specifications.

In this arrangement, if print specifications cannot be implemented because of restrictions of the printer or the post-printing processor, the print-specification determination section outputs zero or more alternative print specifications. Therefore, for other than job definition data having no alternative, the print-specification determination section outputs two or more candidates of alternative print specifications close to the print specifications so that the user can select print specifications from the candidates.

### Form 44

In Form 44, the print method of Form 43 may be configured such that the alternative print specifications include information indicative how much the print specifications to be implemented meet the input print-job definition data.

In this arrangement, the alternative print specifications include information indicative how much the print specifications to be implemented meet the input print-job definition data. This offers the advantage of facilitating evaluation of the alternative print specifications.

### Form 45

In Form 45, the print method of one of Forms 37 to 44 may be configured such that the post-printing process includes paper collation, stitching, bookbinding, folding, packing, and transportation.

In this arrangement, post-printing processors can execute almost all post-printing processing, such as paper collation, stitching, bookbinding, folding, packing, and transportation. This offers the advantage that the use of a combination of post-printing processors allows substantially perfect post-printing processing.

### Form 46

A print program of Form 46 includes computer-readable program code for: receiving input of print-job definition data describing print specifications; obtaining capability information on an available printer; obtaining capability information on an available post-printing processor; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; outputting the print-job setting data generated in the print-specification determination step; and outputting the post-printing-process-job setting data generated in the print-specification determination step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition section, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Thus, printing and post-printing processing can be executed according to the print-job definition data and the obtained printer capability information and post-printing-processor capability information, or print specifications changed as necessary. Moreover, print-job setting data can be generated according to the changed print specifications. Thus the process for implementing print specifications can be automatically searched for with the combination of an available printer and postprocessor, and print-job setting data corresponding to the respective devices can be generated.

### Form 47

A print program of Form 47 includes computer-readable program code for: receiving input of print-job definition data describing print specifications; obtaining capability information on an available printer; obtaining capability information on an available post-printing processor; obtaining content data associated with the print-job definition data received in the print-job-definition-data input step; determining print specifications to be implemented, according to the print specifications described in the print-job definition data received in the print-job-definition-data input step, the printer capability information obtained in the printer-capability-information acquisition step, and the post-printing-processor capability information obtained in the post-printing-processor-capability-information acquisition step, and generating print-job setting data describing print settings for executing printing according to the print specifications and post-printing-process-job setting data describing post-printing-process settings for executing postprocessing of a print medium printed according to the print specifications; processing the content data obtained by the content-data acquisition section according to the print specifications determined in the print-specification determination step; outputting the print-job setting data generated in the print-specification determination step; outputting the post-printing-process-job setting data generated in the print-specification determination step; instructing a printer to print the content data processed in the content-data processing step according to the description of the print-job setting data output in the print-job-setting-data output step; and instructing a post-printing processor to execute postprocessing of the print medium printed by the printer according to the description of the post-printing-process-job setting data output in the post-printing-process-job-setting-data output step.

In this arrangement, after capability information on an available printer is obtained in the printer-capability-information acquisition step, and capability information on an available post-printing processor is obtained in the post-printing-processor-capability-information acquisition step, print specifications to be implemented is determined according to the print specifications described in the print-job definition data received in the print-job-definition-data input step, the printer capability information obtained in the printer-capability-information acquisition step, and the post-printing-processor capability information obtained in the post-printing-processor-capability-information acquisition step; and thus print-job setting data describing print settings for executing printing according to the print specifications and post-printing-process-job setting data describing post-printing-process settings for executing postprocessing of a print medium printed according to the print specifications are generated. Content data associated with the print-job definition data received in the print-job-definition-data input step is obtained in the content-data acquisition step; and the content data obtained in the content-data acquisition step is processed in the content-data processing step according to the print specifications determined in the print-specification determination step; and in the print instruction step, the printer is instructed to print the content data processed in the content-data processing step according to the description of the print-job setting data output in the print-job-setting-data output step. Thus, printing and post-printing processing can be executed according to the print-job definition data and the obtained printer capability information and post-printing-processor capability information, or print specifications changed as necessary. Moreover, print-job setting data can be generated according to the changed print specifications. This offers the advantages that the process for implementing print specifications can be automatically searched for with the combination of an available printer and postprocessor, and print-job setting data corresponding to the respective devices can be generated. Moreover, since the content data is processed appropriately by the content-data processing section, there is no need for processing the content data manually.

### Form 48

In Form 48, the print program of Form 46 or 47 may be configured such that the print-specification determination step includes: an inference module that infers print specifications from the print-job definition data, the printer capability information, and the post-printing-processor capability information and a print-job-setting-rule database that stores predetermined print-job setting rules for the inference module.

With this arrangement, print specifications to be implemented can be inferred by the inference module, and predetermined print-job-setting rules are stored in the print-job-setting-rule database. This offers the advantage that the print-specification determination section can determine print specifications easily with high reproducibility.

### Form 49

In Form 49, the print program of Form 48 may be configured such that the print-job-setting-rule database stores if-then format rules.

In this arrangement, the print-job-setting-rule database includes conditional “if” clauses and resulting “then” clauses. Therefore, when only the conditional clauses are applied, its results are derived. Therefore, the print-specification determination step allows print specifications to be determined automatically.

### Form 50

In Form 50, the print program of Form 49 may be configured such that the “if” clauses are each an AND condition. Unless all of “if” clauses meet the input print-job definition data and the obtained device capability information, the “if” clauses do not become true.

In this arrangement, the “if” clauses are each an AND condition. Therefore, unless all of the “if” clauses meet the input print-job definition data and the obtained device capability information, the “if” clauses do not become true, so that print specifications are not determined. This offers the advantage of preventing unexpected troubles.

### Form 51

In Form 51, the print program of Form 49 or 50 may be configured such that if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed.

In this arrangement, if there are two or more devices that meet the device capability conditions of the if-then format clauses, it is determined whether the respective devices meet the “if” clauses, and then an inner loop is formed for a combination of the devices to determine whether the “if” clauses hold, and multiple times of processing are executed. This offers the advantage of deriving the best results by examining all the available printers and post-printing processors.

### Form 52

In Form 52, the print program of one of Forms 46 to 51 may be configured such that if print specifications cannot be implemented because of restrictions of the printer or the post-printing processor, the print-specification determination step outputs zero or more alternative print specifications.

In this arrangement, if print specifications cannot be implemented because of restrictions of the printer or the post-printing processor, the print-specification determination section outputs zero or more alternative print specifications. Therefore, for other than job definition data having no alternative, the print-specification determination section outputs two or more candidates of alternative print specifications close to the print specifications so that the user can select print specifications from the candidates.

### Form 53

In Form 53, the print program of Form 52 may be configured such that the alternative print specifications include information indicative how much the print specifications to be implemented meet the input print-job definition data.

In this arrangement, the alternative print specifications include information indicative how much the print specifications to be implemented meet the input print-job definition data. This offers the advantage of facilitating evaluation of the alternative print specifications.

### Form 54

In Form 54, the print support method of one of Forms 46 to 53 may be configured such that the post-printing process includes paper collation, stitching, bookbinding, folding, packing, and transportation.

In this arrangement, post-printing processors can execute almost all post-printing processing, such as paper collation, stitching, bookbinding, folding, packing, and transportation. This offers the advantage that the use of a combination of post-printing processors allows substantially perfect post-printing processing.

### Form 55

A recording medium of Form 55 is a computer-readable recording medium in which the print support program of one of Forms 19 to 27 or the print program of one of Forms 46 to 54 is stored.

What is claimed is:

1. A print support apparatus comprising:
a print-job-definition-data input section that receives input of print-job definition data describing print specifications;
a printer-capability-information acquisition section that obtains capability information on an available printer;
a post-printing-processor-capability-information acquisition section that obtains capability information on an available post-printing processor;
a print-specification determination section that determines print specifications to be implemented, according to the print specifications described in the print-job definition data, the printer capability information, and the post-printing-processor capability information;
a first generation section that generates print-job setting data describing print settings for executing printing according to the print specifications;
a second generation section that generates post-printing-process-job setting data describing post-printing-process settings for executing postprocessing of a print medium printed according to the print specifications;
a first output section that outputs the print-job setting data generated by the first generation section; and
a second output section that outputs the post-printing-process-job setting data generated by the second generation section.

2. The print support apparatus according to claim 1, wherein
the print-specification determination section includes:
a print-job-setting-rule database that stores predetermined print-job setting rules; and
an inference section that infers print specifications to be implemented, from the print-job definition data, the printer capability information, and the post-printing-processor capability information on the basis of the print-job-setting-rule database.

3. The print support apparatus according to claim 1, wherein, when the print specifications cannot be implemented because of restrictions of the capability of the printer and the post-printing processor, the print-specification determination section determines alternative print specifications.

4. The print support apparatus according to claim 1, wherein the postprocessing of the print medium includes paper collation, stitching, bookbinding, folding, packing, and transportation.

5. A computer-readable recording medium that stores a print support program comprising:
computer-readable program code for receiving input of print-job definition data describing print specifications;
computer-readable program code for obtaining capability information on an available printer;
computer-readable program code for obtaining capability information on an available post-printing processor;
computer-readable program code for determining print specifications to be implemented, according to the print specifications described in the print-job definition data, the printer capability information, and the post-printing-processor capability information;
computer-readable program code for a first generation step of generating print-job setting data describing print settings for executing printing according to the print specifications;
computer-readable program code for a second generation step of generating post-printing-process-job setting data describing post-printing-process settings for executing postprocessing of a print medium printed according to the print specifications;
computer-readable program code for a first output step of outputting the print-job setting data generated in the first generation step; and
computer-readable program code for a second output step of generating the post-printing-process-job setting data generated in the second generation step.

6. A print system comprising:
a print-job-definition-data input section that receives input of print-job definition data describing print specifications;
a printer-capability-information acquisition section that obtains printer capability information on an available printer;
a first generation section that generates print-job setting information for executing printing by the printer according to the print specifications described in the print-job definition data and the printer capability information;
a second generation section that generates post-printing-process-job setting information for executing postprocessing of a print medium printed according to the print-job setting information;
a post-printing-process-job-setting-information output section that outputs the post-printing-process-job setting information generated by the second generation section;
a print instruction section that instructs the printer to execute printing according to the print-job setting information generated by the first generation section; and
a printing section that execute printing according to the instruction of the print instruction section.

7. The print system according to claim 6, wherein
the first generation section and the second generation section include:
a print-job-setting-rule database that stores print-job setting rules; and
an inference section that generates the print-job setting information and the post-printing-process-job setting information by inference, with reference to the print-job-setting-rule database.

8. The print system according to claim 7, wherein the inference section determines alternative print specifications that meet the print specifications, and automatically generates the print-job setting information and the post-printing-process-job setting information according to the alternative print specifications.
